(19) United States
(12) Patent Application Publication
(10) Pub. No.: US 2025/0292255 A1
(43) Pub. Date: Sep. 18, 2025

(54) ISSUER-AGNOSTIC PAYMENTS USING DYNAMIC ALPHANUMERIC CODES

(71) Applicant: Relay Payments, Inc., Atlanta, GA (US)

(72) Inventor: James Ryan Droege, Atlanta, GA (US)

(21) Appl. No.: 18/603,086

(22) Filed: Mar. 12, 2024

(51) Int. Cl. G06Q 20/40

(52) U.S. Cl. CPC G06Q 20/4012

(57) ABSTRACT

Systems, methods, and computer-readable media are disclosed for issuer-agnostic payments using dynamic authentication codes. In one embodiment, a method can include determining, by a fuel controller having one or more processors coupled to memory, a first alphanumeric code, determining that a first portion of the first alphanumeric code matches a dynamic authentication code, and determining that a second portion of the first alphanumeric code matches a user-specific passcode. The method may include determining a user identifier associated with the first alphanumeric code, determining a fuel allocation amount associated with the user identifier, and causing a fuel dispensing pump to authorize dispensing of fuel corresponding to the fuel allocation amount.

### BACKGROUND

In certain instances, parties may reimburse others for expenses, such as fuel expenses, per diem expenses, maintenance expenses, and so forth. For example, a company may reimburse a truck driver for fuel expenses during transport of a load. In other examples, one person may reimburse another, such as to cover expenses during performance of a task, a company may cover expenses for a contractor or employee, and the like. The opportunity for fraud to occur during such expense reimbursements and/or expense payments may be relatively high. Moreover, for transactions where electronic payment methods are used for payment, such as store purchases, fuel purchases, etc., there is a risk that the electronic payment method can be compromised. For example, a credit card used during a purchase can be skimmed and then used by others for fraudulent purchases. Because credit cards and other electronic payments generally have static information, such as credit card numbers, such fraud may occur relatively frequently. Accordingly, increased security and fraud prevention for electronic payment methods, such as issuer-agnostic payments using dynamic alphanumeric codes, may be desired.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic illustration of an example use case for issuer-agnostic payments using dynamic alphanumeric codes in accordance with one or more example embodiments of the disclosure.

FIG. 2 is a schematic illustration of an example process flow for issuer-agnostic payments using dynamic authentication codes in accordance with one or more example embodiments of the disclosure.

FIG. 3 is a schematic illustration of a hybrid system architecture and data flow for issuer-agnostic payments using dynamic alphanumeric codes in accordance with one or more example embodiments of the disclosure.

FIGS. 4A-4B are schematic illustrations of example use cases for issuer-agnostic payments using dynamic authentication codes in accordance with one or more example embodiments of the disclosure.

FIG. 5 is a schematic illustration of an example point of sale device transaction in accordance with one or more example embodiments of the disclosure.

FIG. 6 is a schematic illustration of an example process flow for conflict resolution of issuer-agnostic payments using dynamic authentication codes in accordance with one or more example embodiments of the disclosure.

FIG. 7 is a schematic block diagram of an illustrative device in accordance with one or more example embodiments of the disclosure.

### DETAILED DESCRIPTION

### Overview

Electronic payment method theft and corresponding fraud is problematic and generally considered a cost of doing business by credit card issuers, banks, and other parties. The use of biometrics and other information during electronic payment transactions reduces the risk of fraud and theft of electronic payment details, but such features are not widely used relative to the number of electronic payments that occur on a daily basis. In particular, payment information for credit cards that are swiped for payment during a transaction are relatively easy to capture and replicate, and subsequently use for fraudulent purposes by third parties. One reason credit card theft is relatively easy is because credit card credentials are generally static and remain the same until a new credit card is issued by a card issuer.

Moreover, certain types of theft, such as that related to reimbursable expenses by, for example, contracted truck drivers, can be difficult to detect. Examples include theft of fuel by reselling diesel fuel purchased using a credit card provided to the driver by a reimbursing party, fraudulent per diem expenses, and the like.

Embodiments of the disclosure include issuer-agnostic payments using dynamic alphanumeric codes that reduce a likelihood, and in many instances prevent, theft of electronic payment method credentials, such as credit card information. Some embodiments provide issuer-agnostic payments using dynamic alphanumeric codes that can be used with any form of electronic payment method, including credit cards, bank accounts, etc. By providing dynamic alphanumeric codes, some embodiments exponentially reduce the likelihood that credit card or other payment information is compromised during a payment transaction. Some embodiments include control systems that control fuel dispensing pumps to ensure not only payment information is not compromised, but also to ensure that fuel theft does not occur. Some embodiments include a dynamic alphanumeric code that can be used for payment during a transaction in lieu of any credit card or other payment method. Certain embodiments allow for input of such codes at a point of sale device, directly at a fuel dispensing pump, and/or at other sales terminals. By using such dynamic alphanumeric codes, even if payment information is intercepted, the alphanumeric code is time-limited and only valid during a certain period of time, after which the alphanumeric code is no longer valid and cannot be used. The alphanumeric code may be associated with one or more payment methods that are not communicated, and therefore remain secure during the transaction. In this manner, theft of payment credentials and risk of fraud are both greatly reduced.

This disclosure relates to, among other things, devices, systems, methods, computer-readable media, techniques, and methodologies for issuer-agnostic payments using dynamic alphanumeric codes. In some instances, machine learning (e.g., deep neural networks, etc.) may be used to determine and identify fraudulent transactions (e.g., performed by truck drivers that are being reimbursed, etc.), determine a fuel allocation amount and/or item purchase allocation amount for a particular truck driver, and so forth. A feedback loop may be used to continually improve accuracy of the machine learning model(s), which may include feedback from customers, operators, or other users.

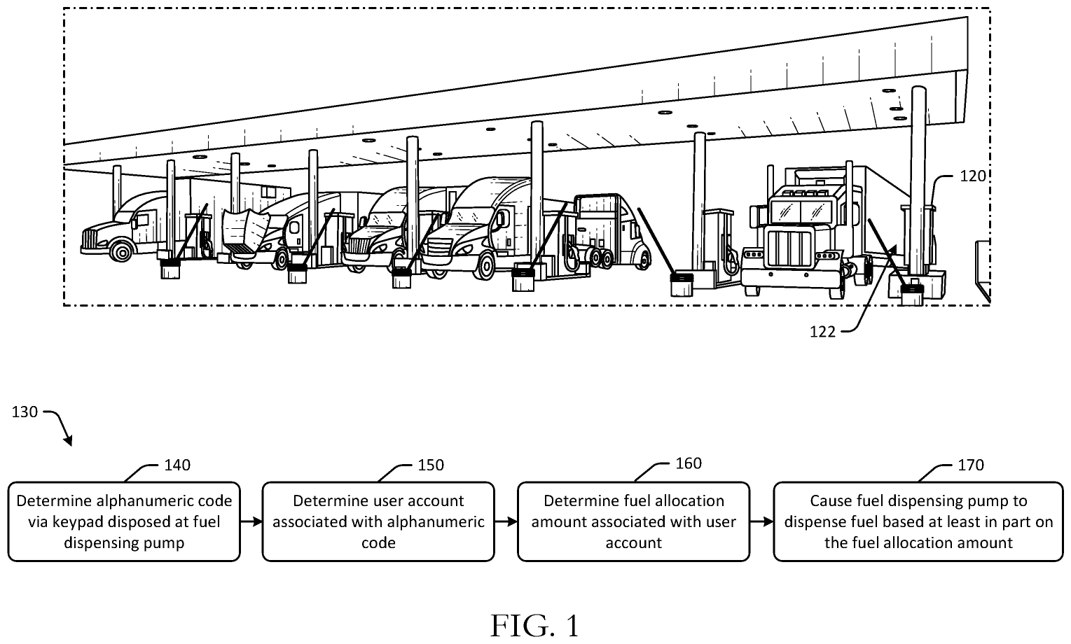

Referring to FIG. 1, an example use case 100 for issuer-agnostic payments using dynamic alphanumeric codes is depicted in accordance with one or more example embodiments of the disclosure. Although discussed in the context of truckers and truck transportation, the issuer-agnostic payments using dynamic alphanumeric codes described herein are more broadly applicable to any transaction in which an electronic payment method is used for payment. Moreover, although discussed in the context of fuel dispensing pumps, it is understood that the present disclosure relates to purchase transactions related to energy, including electricity. For example, a charging station for charging of a battery pack for electric vehicles may be considered a fuel dispensing pump. For clarity, fuel, as used herein, includes at least diesel fuel, gasoline, natural gas, hydrogen, electric vehicle charges, and diesel exhaust fluid. In another example, an energy dispensing station may be a fuel dispensing pump as described herein, where electric vehicles may be charged at energy dispensing stations.

In FIG. 1, a number of trucks may be parked at fuel dispensing pumps 120 of a fuel station. The trucks may be refueling diesel fuel during transport of loads. Typically, such fuel transactions may involve either a truck driver paying for the fuel using a personal payment method and requesting reimbursement, or using a credit card or other payment method provided by an employer or owner of the load being transported. The same payment method may be used for in-store purchases, such as for food, truck maintenance, and so forth. In addition to fraud that can be performed by the truck driver, there is a likelihood that the payment method can be stolen or intercepted during the transaction.

Embodiments of the disclosure reduce, and in some instances, prevent, the occurrence of fraud performed by the truck driver, as well as theft of payment method information. An example process flow 130 may be executed by a local fuel controller disposed at the fuel station (e.g., a control system that controls operation of the fuel dispensing pumps 120 at the fuel station, etc.), or at a remote server, or via a combination thereof. At block 140 of the example process flow 130, the fuel controller may determine an alphanumeric code via a keypad disposed at the fuel dispensing pump 120. For example, some or all of the fuel dispensing pumps 120 may have a keypad 122 disposed at the fuel dispensing pump 120. A credit card terminal, NFC reader, and/or other hardware may also be disposed at the fuel dispensing pump 120.

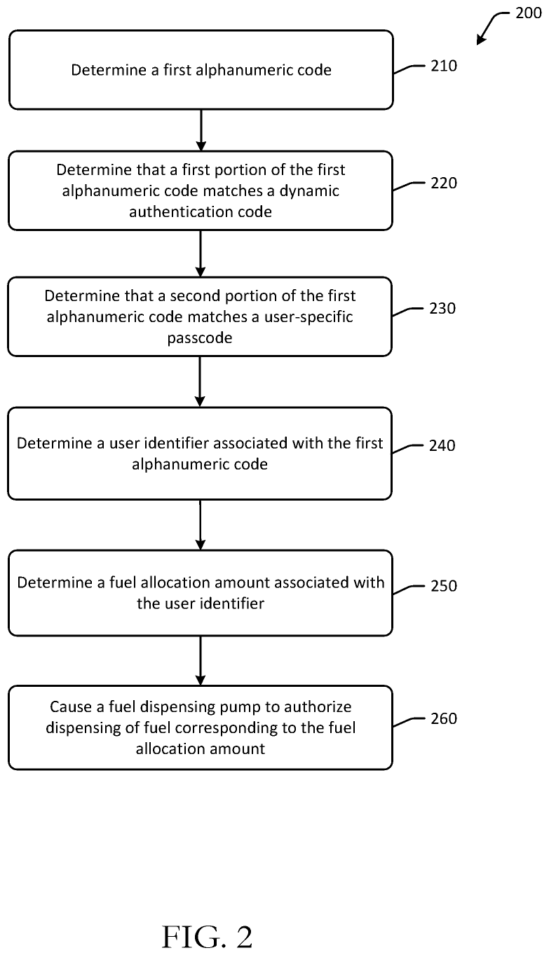

Rather than using a credit card or other hardware to initiate a transaction at the fuel dispensing pump 120, a driver may enter an alphanumeric code as described in detail with respect to at least FIGS. 2-4B. The fuel controller may determine the alphanumeric code via the keypad 122.

At block 150, the fuel controller may determine a user account associated with the alphanumeric code. For example, the alphanumeric code may be a dynamic alphanumeric code that is associated with a user account. The user account may be associated with one or more payment methods, such as credit cards, bank accounts, etc. The fuel controller may have user account information stored locally or may communicate with one or more remote servers to determine the user account.

At block 160, the fuel controller may determine a fuel allocation amount associated with the user account. For example, the user account may have a predetermined amount of fuel or dollar value associated with fuel purchases that is authorized for the user account. The fuel allocation amount may be set by an employer or other party reimbursing the driver for the fuel expense. In some embodiments, the fuel controller may use additional factors, such as a time since last fueling, an amount of fuel previously provided to the user account, a geolocation of the fuel station relative to a last refueling event, a distance from destination, and so forth to determine the fuel allocation amount. For electric charging station fuel dispensing pumps, fuel allocation data may be an amount of charge (e.g., kWh, etc.), a dollar value, a charging time, etc. that is authorized for the user account.

At block 170, the fuel controller may cause the fuel dispensing pump to dispense fuel based at least in part on the fuel allocation amount. The fuel controller may automatically activate the fuel pump without manual or operator intervention for the fuel allocation amount, after which the fuel controller may cause the fuel dispensing pump to deactivate.

In this manner, the payment information remains secure as the dynamic alphanumeric code is used to facilitate the fuel purchase. The same process can be used in a store at the fuel station, where the dynamic alphanumeric code can be input at a point of sale terminal inside the store and used to identify the user account and corresponding item purchase allocation amount. The fuel controller may be used to authenticate or otherwise facilitate in-store purchases as well. Payments may be processed using normal payment processing rails provided by issuers once approved by the fuel controller, thereby allowing middleware and last mile processing of transactions to remain unaffected, while providing improved security.

For electric vehicles, such as semi-trucks, delivery trucks, electric cars, and so forth, the fuel dispensing pumps may be electric charging stations that allow for charging of electric vehicle batteries. The electric charging stations may include input devices, such as keypads, displays, etc. at which alphanumeric codes can be entered in accordance with one or more embodiments as described herein. The same authentication and allocation processes and operations described herein can be used with such electric charging stations. For electric charging station fuel dispensing pumps, fuel allocation data may be an amount of charge (e.g., kWh, etc.), a dollar value, a charging time, etc. that is authorized for the user account.

Example embodiments of the disclosure provide a number of technical features or technical effects. For example, in accordance with example embodiments of the disclosure, certain embodiments of the disclosure may automatically manage fuel dispensing pump operation. Certain embodiments may be configured to provide improved security for electronic payments, and may use various factors to reduce a likelihood of fraud performed by truck drivers or others that are to be reimbursed for expenses. As a result of improved functionality, manual efforts may be redirected to other tasks. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Process and Use Cases

FIG. 2 depicts an example process flow 200 for issuer-agnostic payments using dynamic authentication codes in accordance with one or more example embodiments of the disclosure. While example embodiments of the disclosure may be described in the context of truck drivers and fuel, it should be appreciated that the disclosure is more broadly applicable to any type of purchase transaction involving a physical or electronic payment method, such as credit cards, debit cards, etc. Some or all of the blocks of the process flows in this disclosure may be performed in a distributed manner across any number of devices. The operations of the process flow 200 may be optional and may be performed in a different order.

At block 210 of the process flow 200, computer-executable instructions stored on a memory of a device, such as a remote server or a fuel controller, may be executed to determine a first alphanumeric code. For example, a remote server may determine a first alphanumeric code. In some embodiments, the remote server may receive the first alphanumeric code from a fuel controller at a fuel station. In other embodiments, the fuel controller may determine the first alphanumeric code locally, such as input via a keypad or display at a fuel dispensing pump. The first alphanumeric code may be a dynamic alphanumeric code that includes one or more portions. For example, the first alphanumeric code may include a static first portion that identifies an entity, a second portion that is a user-configurable passcode, and a third portion that is dynamically generated. Any number of characters may be included. In one particular example, the first alphanumeric code may have a length of twelve characters. Other embodiments may have different numbers or sequences of characters.

In one embodiment, the first alphanumeric code may be determined by a fuel controller having one or more processors coupled to memory. The first alphanumeric code can be input at a keypad disposed at a fuel dispensing pump, at a point of sale device in a store, and/or other devices. For example, the first alphanumeric code can be input at a point of sale terminal that is decoupled from the fuel dispensing pump. The first alphanumeric code may be a dynamic authentication code generated using a time-based one-time password algorithm. In one example, a first portion of the first alphanumeric code is dynamic, and a second portion of the first alphanumeric code is static. The first portion of the first alphanumeric code can be presented via a display of an electronic device having a credit card form factor. In other embodiments, a portion of the first alphanumeric code can be presented via a mobile application at a mobile device.

At block 220 of the process flow 200, computer-executable instructions stored on a memory of a device, such as a remote server or a fuel controller, may be executed to determine that a first portion of the first alphanumeric code matches a dynamic authentication code. For example, a remote server may determine that a first portion of the first alphanumeric code matches a dynamic authentication code. The remote server may be synced with the time-based one-time password algorithm executing on the user device (e.g., mobile device, credit card-form factor device having a display, etc.), such that the remote server can identify the user account associated with a particular alphanumeric code. In some embodiments, the fuel controller may determine the user account locally.

At block 230 of the process flow 200, computer-executable instructions stored on a memory of a device, such as a remote server or a fuel controller, may be executed to determine that a second portion of the first alphanumeric code matches a user-specific passcode. For example, a remote server may determine that a second portion of the first alphanumeric code matches a user-specific passcode. The alphanumeric code may include a portion that changes with time, as well as a portion that is set by the user and enhances security by disallowing use of the time-based password alone for purchases. The fuel controller or remote server may determine that the second portion of the first alphanumeric code matches a stored user-specific passcode, in addition to the first portion of the first alphanumeric code matching the dynamic authentication code.

At block 240, computer-executable instructions stored on a memory of a device, such as a remote server or a fuel controller, may be executed to determine a user identifier associated with the first alphanumeric code. For example, the remote server may determine a user identifier associated with the first alphanumeric code. The user identifier may be a user account and/or may be associated with one or more payment methods, such as credit cards. For example, a particular credit card may be associated with fuel transactions, another credit card may be associated with item or in-store purchases, and so forth.

At block 250, computer-executable instructions stored on a memory of a device, such as a remote server or a fuel controller, may be executed to determine a fuel allocation amount associated with the user identifier. For example, the remote server may determine a fuel allocation amount associated with the user identifier. The user identifier or user account may be associated with a fuel allocation amount, which may be indicated by an amount of fuel, a value of fuel, and/or indicators. Similarly, the user account may be associated with an item purchase amount for items, and so forth. The fuel controller and/or remote server may determine the fuel allocation amount associated with the user identifier in order to determine whether the purchaser is entitled to fuel (or items). In some embodiments, the remote server and/or fuel controller may use factors such as a tank capacity value, an initial fueling location, a gallon allotment for a set period of time, a fuel measurement, an initial fueling time, and/or average fuel consumption to determine fuel allocation amounts.

At block 260, computer-executable instructions stored on a memory of a device, such as a remote server or a fuel controller, may be executed to cause a fuel dispensing pump, which may be an electric charging station, to authorize dispensing of fuel or otherwise activate charging corresponding to the fuel allocation amount. For example, the remote server may cause a fuel dispensing pump to authorize dispensing of fuel corresponding to the fuel allocation amount. In some embodiments, the fuel controller may send a signal to the fuel dispensing pump to activate the fuel dispensing pump and being dispensing fuel. The fuel dispensing pump may be preauthorized to dispense up to the fuel allocation amount. Once dispensing is complete, the fuel controller may send the purchase data to one or more remote servers for downstream processing of the transaction using the payment method associated with the user account. Such data may include an amount of fuel pumped, a fuel price per gallon, a time stamp, and/or any other relevant information about the transaction. In another example, the fuel controller or other control system may cause an energy dispensing station, which may be a fuel pump, an electric vehicle charging station, and so forth, to authorize a transfer of energy corresponding to the allocation amount. The transfer of energy may be a transfer of electricity, a transfer of fuel, and the like.

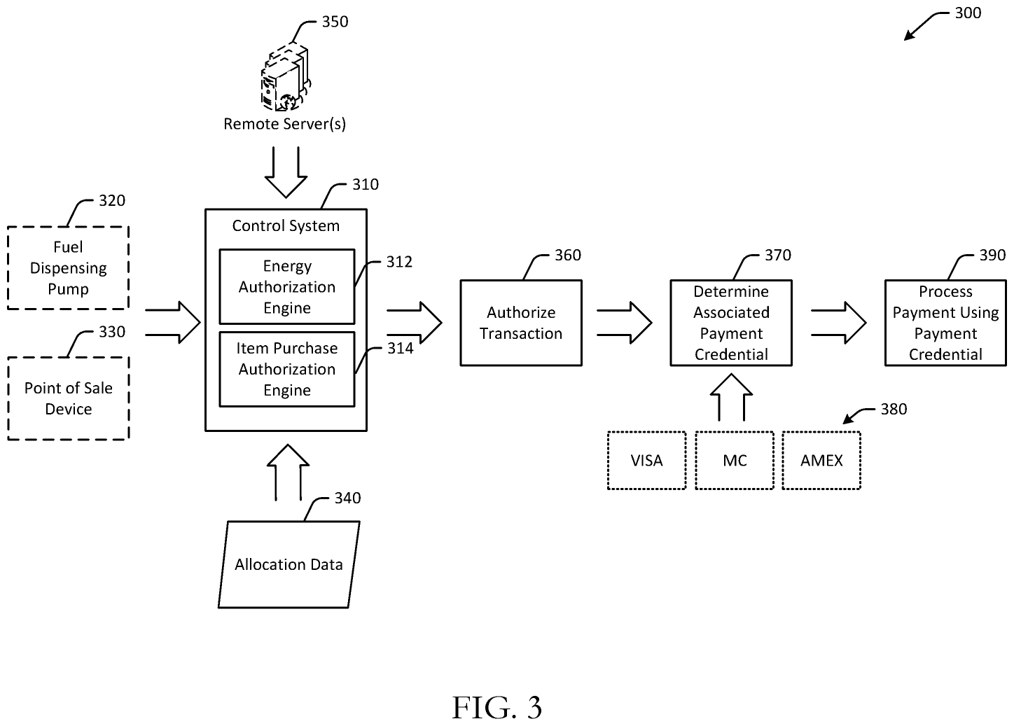

FIG. 3 is a schematic illustration of a hybrid system architecture and data flow 300 for issuer-agnostic payments using dynamic alphanumeric codes in accordance with one or more example embodiments of the disclosure. Other embodiments may have different architectures and/or include additional, fewer, or different components.

In FIG. 3, the system architecture may include a control system 310 that is disposed at a fuel station, such as a fuel controller. The control system 310 may be in communication with one or more optional remote servers 350. The control system 310 may be configured to control dispensing of fuel via control of fuel dispensing pumps at the fuel station. The control system 310 may be configured to receive information, such as alphanumeric codes, from fuel dispensing pumps 320 and/or point of sale devices 330. The control system 310 may be configured to determine allocation data 340, which may be locally available or may be determined via communication with the one or more remote servers 350. The allocation data 340 may indicate fuel allocation data, item purchase allocation data, and/or other limits associated with individual user accounts. The control system 310 may use the allocation data to determine whether to authorize purchases, and/or for an amount to authorize in a transaction.

The control system 310 may include one or more computer-executable module(s), such as an energy authorization engine 312 and an item purchase authorization engine 314. The energy authorization engine 312 may be configured to authorize purchases of fuel, including electricity for charging of electric vehicles. The control system 310 may determine the alphanumeric code input via the fuel dispensing pump 320 and/or point of sale device 330. The control system 310 may determine whether the alphanumeric code is valid, and if so, the control system 310 may determine a user account associated with the alphanumeric code. In some embodiments, the control system 310 or fuel controller is configured to locally determine that the first portion of the first alphanumeric code matches the dynamic authentication code. In other embodiments, the control system 310 may transmit the first portion of the first alphanumeric code to the remote server 350, and may receive a validation notification indicating the first portion of the first alphanumeric code matches the dynamic authentication code.

In some embodiments, the control system 310 may determine the user account locally, whereas in other embodiments, the control system 310 may determine the user account via communication with the remote server 350. The control system 310 may execute the fuel dispensing authorization engine 312 to determine how much fuel the user account is authorized to purchase at a particular time or location. Similarly, the control system 310 may execute the item purchase authorization engine 314 to determine how much in value and/or how many items the user account is authorized to purchase at a particular time or location.

At block 360 the control system 310 may determine, using the allocation data 340, that a transaction is authorized and may output an authorize transaction action, such as activating a fuel dispensing pump. At block 370, the control system 310 may determine an associated payment credential that is associated with the user account. The payment credential can be issuer-agnostic, and may be associated with any number of issuers 380, such as VISA®, MASTERCARD®, AMEX®, and so forth. The control system 310 may communicate with the remote server 350 to determine the payment credential. At block 390, the control system 310 may cause, or may communicate with the remote server 350 to cause, the payment to be processed using the payment credential. In this manner, the system can be deployed on a frontend without modification to downstream payment processing. For example, the control system 310 may determine that fuel dispensing is complete, and may determine a value associated with the fuel dispensing. The control system 310 may therefore determine a payment account associated with the user identifier, and may cause the value to be processed as a credit card transaction via the payment account.

In one example, the control system 310 may determine whether a purchase request satisfies certain rules and/or constraints (e.g., based on purchase history data) corresponding to the user (e.g., driver identifier and/or company identifier, etc.). Purchase history data may include, for example, prior purchase amounts, prior purchase items, prior purchase categories, prior purchase dates, prior purchase times, and/or prior purchase locations.

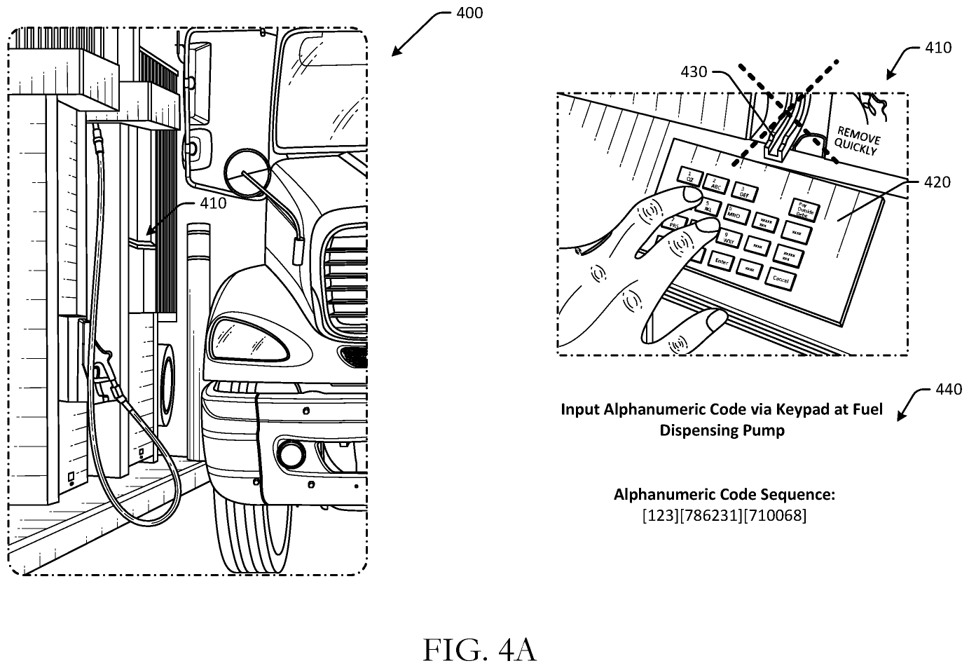

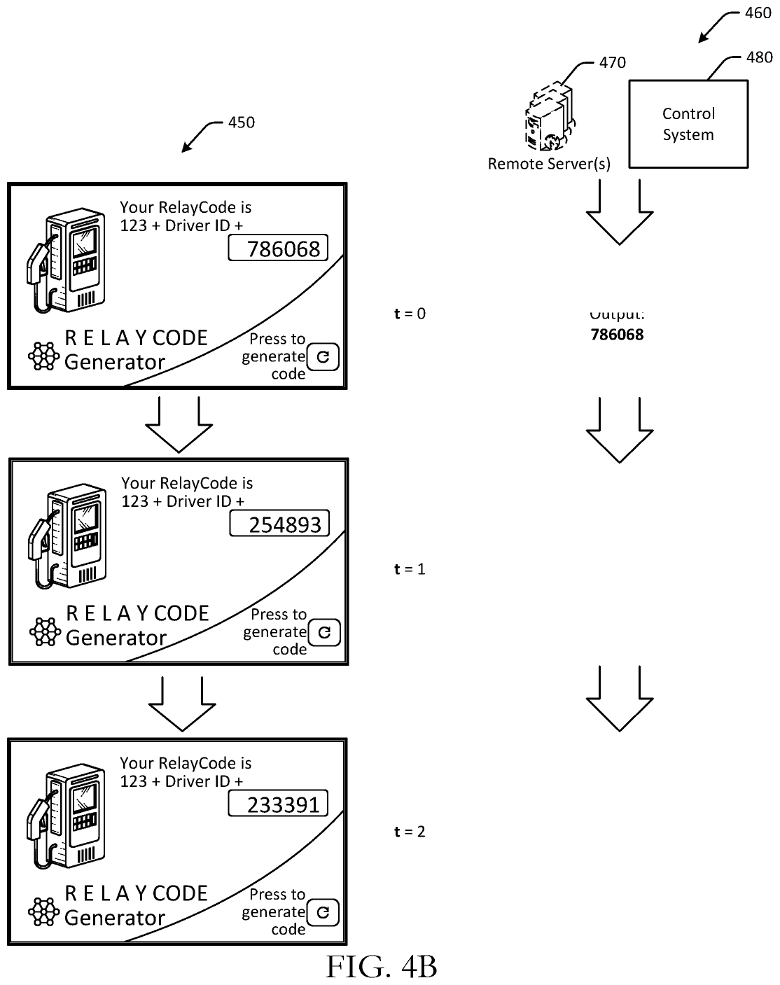

FIGS. 4A-4B are schematic illustrations of example use cases 400 for issuer-agnostic payments using dynamic authentication codes in accordance with one or more example embodiments of the disclosure. The examples of FIGS. 4A-4B are for illustrative purposes only. Other embodiments may have different configurations, features, and/or layouts.

In FIG. 4A, a first example use case 400 is presented. A truck may be at a fuel dispensing pump 410. The fuel dispensing pump 410 may include a keypad 420 that may be physical or digital (e.g., at a display, etc.). The fuel dispensing pump 410 may also include a credit card terminal 430. However, users may not need to use the credit card terminal 430 as the dynamic alphanumeric codes may be used in lieu of any credit cards or other hardware. A user may input an alphanumeric code 440 using the keypad 420.

The alphanumeric code 440 may have one or more portions arranged in a sequence. For example, a first portion may have three characters, a second portion may have six characters, and a third portion may have six characters. Any number of characters may be used. Some or all of the characters may be dynamically generated. Other embodiments may have different sequences or arrangements of the portions.

In FIG. 4B, an example schematic illustrates the dynamic alphanumeric code 440 for a particular user over time. A user may have a generator device 450, which may have a credit card-form factor, that presents a portion of the dynamic alphanumeric code 440. The portion that is presented may change over time, as denoted by t=0, t=1, t=2, etc. The presented portion of the dynamic alphanumeric code 440 may be locally determined using a time-based one-time password algorithm flashed onto the device 450. In other embodiments, the portion may be presented via a mobile application on a mobile device, etc. In one embodiment, the generator device 450 may have a display, battery, and a logic board. The generator device 450 may be a “dumb” device or may optionally not have a radio or otherwise be configured for internet connectivity. The generator device 450 may present a portion of the dynamic alphanumeric code 440 to the user, and the user may know the additional portion(s) of the dynamic alphanumeric code 440. For example, the user may select a user-configurable password as a portion of the dynamic alphanumeric code 440. Some portion(s) of the dynamic alphanumeric code 440 may be static.

One or more synced computer systems 460, such as a remote server 470 and/or a control system 480, such as a fuel controller, may be synced to the time-based one-time password presented by the generator device 450. As a result, the synced computer systems 460 may know a current value of the time-based algorithm output presented at the generator device 450, as well as optionally prior values and/or expected values of the time-based algorithm output that were or will be presented by the generator device 450. In this manner, using the password set by the user and the optional additional portions, the synced computer systems 460 can identify a user account associated with a particular dynamic alphanumeric code 440.

Accordingly, in one embodiment, a first portion of a first alphanumeric code is presented via a display of an electronic device, such as the generator device 450, having a credit card form factor. The electronic device can be devoid of an antenna. In some embodiments, a second portion of the first alphanumeric code is shorter than the first portion of the first alphanumeric code. The dynamic alphanumeric code 440 can include a third portion that is static, such as an employer identifier, and the first alphanumeric code has a sequence of the third portion, the second portion, and the first portion.

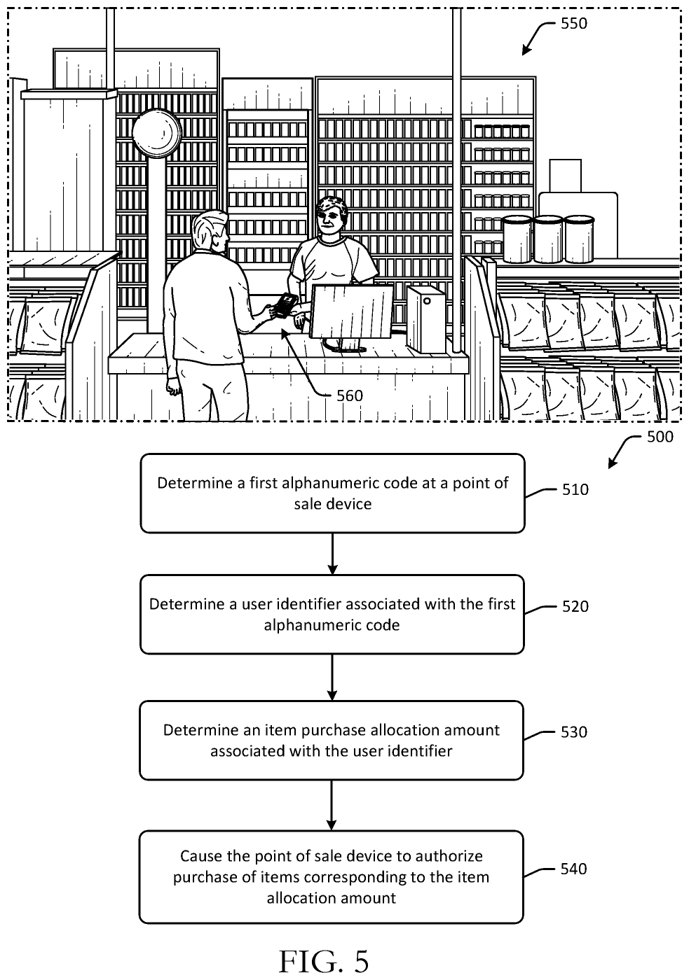

FIG. 5 is a schematic illustration of an example point of sale device transaction in accordance with one or more example embodiments of the disclosure. Other embodiments may have different architectures and/or include additional, fewer, or different components. An example process flow 500 for issuer-agnostic payments using dynamic authentication codes is depicted in accordance with one or more example embodiments of the disclosure. Some or all of the blocks of the process flows in this disclosure may be performed in a distributed manner across any number of devices. The operations of the process flow 500 may be optional and may be performed in a different order.

At block 510, a first alphanumeric code may be determined at a point of sale device. For example, a user at an in-store payment counter 550 may use a point of sale device 560 to input a first alphanumeric code to complete payment for a transaction. At block 520, a user account or user identifier associated with the first alphanumeric code may be determined. For example, a fuel controller at the fuel station or a remote server may be used to determine the user account. At block 530, an item purchase allocation amount associated with the user account may be determined. At block 540, the point of sale device may be caused to authorize purchase of items corresponding to the item allocation amount. In some embodiments, the type of items that can be purchased may be restricted in addition to the amount or value of items, as set in rules or criteria associated with the user account.

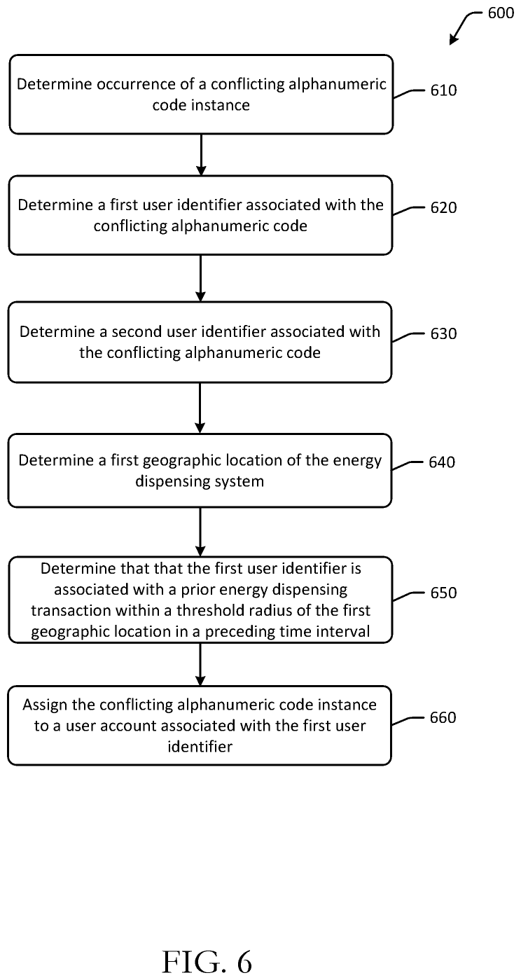

FIG. 6 depicts an example process flow 600 for issuer-agnostic payments using dynamic authentication codes in accordance with one or more example embodiments of the disclosure. Some or all of the blocks of the process flows in this disclosure may be performed in a distributed manner across any number of devices. The operations of the process flow 600 may be optional and may be performed in a different order.

In rare instances, a dispute or conflict may occur where two users have the same passcodes and the corresponding dynamic codes are the same for a period of time. In such instances, where a transaction occurs while two users could potentially be associated with the transaction at the same time, some embodiments may request a second code or a time delay, as the same code will not occur for the two users again. However, some embodiments may use additional factors to determine a correct user account and process the transaction.

At block 610, a remote server may determine occurrence of a conflicting alphanumeric code instance. At block 620, the remote server may determine a first user identifier associated with the conflicting alphanumeric code. At block 630, the remote server may determine a second user identifier associated with the conflicting alphanumeric code. At block 640, a first geographic location of the energy dispensing system, such as a fuel dispensing pump, electric charging station, etc., or point of sale device at which the alphanumeric code was entered. At block 650, the remote server may determine that the first user identifier is associated with a prior energy dispensing transaction within a threshold radius or distance of the first geographic location in a preceding time interval. For example, the first user identifier may have purchased fuel within a 200 mile radius 8 hours earlier. At block 660, the remote server may assign the conflicting alphanumeric code instance to a user account associated with the first user identifier, as the first user identifier is the most likely purchaser.

One or more operations of the methods, process flows, or use cases of FIGS. 1-6 may have been described above as being performed by a user device, or more specifically, by one or more program module(s), applications, or the like executing on a device. It should be appreciated, however, that any of the operations of the methods, process flows, or use cases of FIGS. 1-6 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-6 may be described in the context of the illustrative devices, it should be appreciated that such operations may be implemented in connection with numerous other device configurations.

The operations described and depicted in the illustrative methods, process flows, and use cases of FIGS. 1-6 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Device Architecture

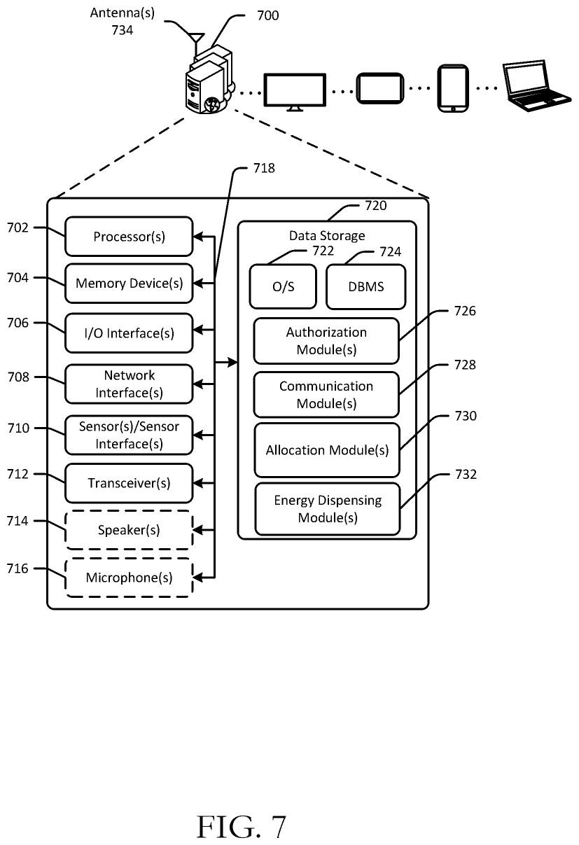

FIG. 7 is a schematic block diagram of an illustrative remote server 700 in accordance with one or more example embodiments of the disclosure. The remote server 700 may include any suitable computing device capable of receiving and/or generating data including, but not limited to, a mobile device such as a smartphone, tablet, e-reader, wearable device, or the like; a desktop computer; a laptop computer; or the like. The remote server 700 may correspond to an illustrative device configuration for the devices of FIGS. 1-6.

The remote server 700 may be configured to communicate via one or more networks with one or more servers, point of sale devices, fuel dispensing pumps, user devices, or the like. In some embodiments, a single remote server or single group of remote servers may be configured to perform more than one type of correlation and/or machine learning functionality.

Example network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the remote server 700 may include one or more processors (processor(s)) 702, one or more memory devices 704 (generically referred to herein as memory 704), one or more input/output (I/O) interface(s) 706, one or more network interface(s) 708, one or more sensors or sensor interface(s) 710, one or more transceivers 712, one or more optional speakers 714, one or more optional microphones 716, and data storage 720. The remote server 700 may further include one or more buses 718 that functionally couple various components of the remote server 700. The remote server 700 may further include one or more antenna(s) 734 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 718 may include at least one of a system bus, a memory bus, an address bus, or a message bus, and may permit exchange of information (e.g., data (including computer-executable code), signaling, etc.) between various components of the remote server 700. The bus(es) 718 may include, without limitation, a memory bus or a memory controller, a peripheral bus, an accelerated graphics port, and so forth. The bus(es) 718 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 704 of the remote server 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 704 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 704 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 720 may include removable storage and/or non-removable storage including, but not limited to, magnetic storage, optical disk storage, and/or tape storage. The data storage 720 may provide non-volatile storage of computer-executable instructions and other data. The memory 704 and the data storage 720, removable and/or non-removable, are examples of computer-readable storage media (CRSM) as that term is used herein.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to memory 704 for use by the processor(s) 702 during the execution of the computer-executable instructions. Moreover, output data generated as a result of execution of the computer-executable instructions by the processor(s) 702 may be stored initially in memory 704, and may ultimately be copied to data storage 720 for non-volatile storage.

More specifically, the data storage 720 may store one or more operating systems (O/S) 722; one or more database management systems (DBMS) 724; and one or more program module(s), applications, engines, computer-executable code, scripts, or the like such as, for example, one or more authorization module(s) 726, one or more communication module(s) 728, one or more allocation module(s) 730, and/or one or more energy dispensing module(s) 732. Some or all of these module(s) may be sub-module(s). Any of the components depicted as being stored in data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in data storage 720 may support functionality described in reference to correspondingly named components earlier in this disclosure.

The data storage 720 may further store various types of data utilized by components of the remote server 700. Any data stored in the data storage 720 may be loaded into the memory 704 for use by the processor(s) 702 in executing computer-executable code. In addition, any data depicted as being stored in the data storage 720 may potentially be stored in one or more datastore(s) and may be accessed via the DBMS 724 and loaded in the memory 704 for use by the processor(s) 702 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 7, the datastore(s) may include, for example, user preference information, customer and/or user account allocation information, user profile information, and other information.

The processor(s) 702 may be configured to access the memory 704 and execute computer-executable instructions loaded therein. For example, the processor(s) 702 may be configured to execute computer-executable instructions of the various program module(s), applications, engines, or the like of the remote server 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 702 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 702 may be capable of supporting any of a variety of instruction sets.

Referring now to functionality supported by the various program module(s) depicted in FIG. 7, the authorization module(s) 726 may include computer-executable instructions, code, or the like that responsive to execution by one or more of the processor(s) 702 may perform functions including, but not limited to, determining whether to authorize a transaction, controlling point of sale devices, causing point of sale devices to approve transactions, determining payment credentials associated with user accounts, determining validity of alphanumeric codes, determining user accounts associated with alphanumeric codes, and the like.

The communication module(s) 728 may include computer-executable instructions, code, or the like that responsive to execution by one or more of the processor(s) 702 may perform functions including, but not limited to, communicating with one or more devices, for example, via wired or wireless communication, communicating with remote servers, communicating with remote datastores, sending or receiving notifications or approvals, communicating with cache memory data, and the like.

The allocation module(s) 730 may include computer-executable instructions, code, or the like that responsive to execution by one or more of the processor(s) 702 may perform functions including, but not limited to, determining fuel allocation amounts, determining user accounts, determining item purchase amounts, and the like.

The energy dispensing module(s) 732 may include computer-executable instructions, code, or the like that responsive to execution by one or more of the processor(s) 702 may perform functions including, but not limited to, controlling fuel dispensing pump operation, determining amounts of fuel dispensed, determining alphanumeric codes input at a fuel dispensing pump, and the like.

Referring now to other illustrative components depicted as being stored in the data storage 720, the O/S 722 may be loaded from the data storage 720 into the memory 704 and may provide an interface between other application software executing on the remote server 700 and hardware resources of the remote server 700. More specifically, the O/S 722 may include a set of computer-executable instructions for managing hardware resources of the remote server 700 and for providing common services to other application programs (e.g., managing memory allocation among various application programs). The O/S 722 may include any operating system now known or which may be developed in the future including, but not limited to, any server operating system, any mainframe operating system, or any other proprietary or non-proprietary operating system.

The DBMS 724 may be loaded into the memory 704 and may support functionality for accessing, retrieving, storing, and/or manipulating data stored in the memory 704 and/or data stored in the data storage 720. The DBMS 724 may use any of a variety of database models (e.g., relational model, object model, etc.) and may support any of a variety of query languages. The DBMS 724 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the remote server 700 is a mobile device, the DBMS 724 may be any suitable light-weight DBMS optimized for performance on a mobile device.

Referring now to other illustrative components of the remote server 700, the input/output (I/O) interface(s) 706 may facilitate the receipt of input information by the remote server 700 from one or more I/O devices as well as the output of information from the remote server 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the remote server 700 or may be separate. The I/O devices may further include, for example, any number of peripheral devices such as data storage devices, printing devices, and so forth.

The I/O interface(s) 706 may also include an interface for an external peripheral device connection such as universal serial bus (USB), FireWire, Thunderbolt, Ethernet port or other connection protocol that may connect to one or more networks. The I/O interface(s) 706 may also include a connection to one or more of the antenna(s) 734 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, ZigBee network, etc.

The remote server 700 may further include one or more network interface(s) 708 via which the remote server 700 may communicate with any of a variety of other systems, platforms, networks, devices, and so forth. The network interface(s) 708 may enable communication, for example, with one or more wireless routers, one or more host servers, one or more web servers, and the like via one or more of networks.

The antenna(s) 734 may include any suitable type of antenna depending, for example, on the communications protocols used to transmit or receive signals via the antenna(s) 734. Non-limiting examples of suitable antennas may include directional antennas, non-directional antennas, dipole antennas, folded dipole antennas, patch antennas, multiple-input multiple-output (MIMO) antennas, or the like. The antenna(s) 734 may be communicatively coupled to one or more transceivers 712 or radio components to which or from which signals may be transmitted or received.

As previously described, the antenna(s) 734 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 734 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11 g, 802.11n), 5 GHz channels (e.g., 802.11n, 802.11ac), or 60 GHz channels (e.g., 802.11ad). In alternative example embodiments, the antenna(s) 734 may be configured to transmit or receive radio frequency signals within any suitable frequency range forming part of the unlicensed portion of the radio spectrum.

The antenna(s) 734 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 712 may include any suitable radio component(s) for—in cooperation with the antenna(s) 734—transmitting or receiving radio frequency (RF) signals in the bandwidth and/or channels corresponding to the communications protocols utilized by the remote server 700 to communicate with other devices. The transceiver(s) 712 may include hardware, software, and/or firmware for modulating, transmitting, or receiving—potentially in cooperation with any of antenna(s) 734—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 712 may further include hardware, firmware, or software for receiving GNSS signals. The transceiver(s) 712 may include any known receiver and baseband suitable for communicating via the communications protocols utilized by the remote server 700. The transceiver(s) 712 may further include a low noise amplifier (LNA), additional signal amplifiers, an analog-to-digital (A/D) converter, one or more buffers, a digital baseband, or the like.

The sensor(s)/sensor interface(s) 710 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The optional speaker(s) 714 may be any device configured to generate audible sound. The optional microphone(s) 716 may be any device configured to receive analog sound input or voice data.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the remote server 700, and/or hosted on other computing device(s) accessible via one or more networks, may be provided to support functionality provided by the program module(s), applications, or computer-executable code depicted in FIG. 7 and/or additional or alternate functionality. Further, functionality may be modularized differently such that processing described as being supported collectively by the collection of program module(s) depicted in FIG. 7 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 7 may be implemented, at least partially, in hardware and/or firmware across any number of devices.

It should further be appreciated that the remote server 700 may include alternate and/or additional hardware, software, or firmware components beyond those described or depicted without departing from the scope of the disclosure. More particularly, it should be appreciated that software, firmware, or hardware components depicted as forming part of the remote server 700 are merely illustrative and that some components may not be present or additional components may be provided in various embodiments. While various illustrative program module(s) have been depicted and described as software module(s) stored in data storage 720, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

1-21. (canceled)

22. A method comprising:
determining, by a fuel controller of a fuel dispensing pump, the fuel controller comprising one or more processors coupled to memory, a first alphanumeric code, wherein the first alphanumeric code is input at an input device coupled to the fuel pump;
determining that a first portion of the first alphanumeric code matches a dynamic authentication code that changes at periodic intervals;
determining that a second portion of the first alphanumeric code matches a user-specific passcode that is static until changed by a user;
determining a user identifier associated with the first alphanumeric code;
determining a fuel allocation amount associated with the user identifier, wherein the fuel allocation amount is determined based at least in part on a trip identifier associated with the user identifier; and
causing a fuel dispensing pump to authorize dispensing of fuel corresponding to the fuel allocation amount.

23. The method of claim 22, wherein the input device is a keypad disposed at the fuel dispensing pump.

24. The method of claim 22, further comprising:
determining a second alphanumeric code at a payment terminal coupled to a point of sale device;
determining that the second alphanumeric code is associated with the user identifier;
determining an item allocation amount associated with the user identifier; and
causing the point of sale device to authorize purchase of items corresponding to the item allocation amount.

25. The method of claim 22, wherein the user identifier is a first user identifier, the method further comprising:
determining a second user identifier associated with the first alphanumeric code;
determining a first geographic location of the fuel dispensing pump; and
prior to causing the fuel dispensing pump to authorize dispensing of fuel, determining that the second user identifier is associated with a prior fuel dispensing transaction within a threshold radius of the first geographic location in a preceding time interval.

26. The method of claim 22, further comprising:
determining that fuel dispensing is complete;
determining a value associated with the fuel dispensing;
determining a payment account associated with the user identifier; and
causing, by a remote server, the value to be processed as a credit card transaction via the payment account.

27. The method of claim 22, further comprising:
transmitting the first portion of the first alphanumeric code to a remote server; and
receiving a validation notification indicating the first portion of the first alphanumeric code matches the dynamic authentication code.

28. The method of claim 22, wherein the fuel controller is configured to locally determine that the first portion of the first alphanumeric code matches the dynamic authentication code.

29. The method of claim 22, wherein the dynamic authentication code is generated using a time-based one-time password algorithm.

30. The method of claim 22, wherein the first portion of the first alphanumeric code is dynamic, and wherein the second portion of the first alphanumeric code is static.

31. The method of claim 30, wherein the first portion of the first alphanumeric code is presented via a display of an electronic device having a credit card form factor with credit card dimensions, and wherein the electronic device is devoid of an antenna.

32. The method of claim 30, wherein the fuel dispensing pump is an electric vehicle charging station.

33. The method of claim 30, wherein the second portion of the first alphanumeric code is shorter than the first portion of the first alphanumeric code.

34. The method of claim 30, wherein the first alphanumeric code further comprises a third portion that is static, and wherein the first alphanumeric code has a sequence of the third portion, the second portion, and the first portion.

35. The method of claim 30, wherein the first portion of the first alphanumeric code is presented via a display of a mobile device.

36. The method of claim 22, wherein the first alphanumeric code is input at the input device at a first time interval, and is input at a point of sale terminal that is decoupled from the fuel dispensing pump at a second time interval.

37. A system comprising:
a device; and
a controller comprising memory comprising computer-executable instructions and one or more computer processors configured to access the memory and execute the computer-executable instructions to:
determine a first alphanumeric code via an input device disposed at an energy dispensing station;
determine that a first portion of the first alphanumeric code matches a dynamic authentication code that changes at periodic intervals;
determine that a second portion of the first alphanumeric code matches a user-specific passcode that is static until changed by a user;
determine a user identifier associated with the first alphanumeric code;
determine an allocation amount associated with the user identifier, wherein the allocation amount is determined based at least in part on a trip identifier associated with the user identifier; and
cause the energy dispensing station to authorize a transfer of energy corresponding to the allocation amount.

38. The system of claim 37, wherein the one or more computer processors are further configured to access the memory and execute the computer-executable instructions to:
determine an item purchase allocation amount associated with the user identifier;
determine a second alphanumeric code;
determine that the second alphanumeric code is associated with the user identifier;
determine an item allocation amount associated with the user identifier; and
cause a point of sale device to authorize purchase of items corresponding to the item allocation amount.

39. The system of claim 37, wherein the user identifier is a first user identifier, and the one or more computer processors are further configured to access the memory and execute the computer-executable instructions to:
determine a second user identifier associated with the first alphanumeric code;
determine a first geographic location of the energy dispensing station; and
determine that the second user identifier is associated with a prior transaction within a threshold radius of the first geographic location in a preceding time interval.

40. The system of claim 37, wherein the one or more computer processors are further configured to access the memory and execute the computer-executable instructions to:
transmit the first portion of the first alphanumeric code to a remote server; and
receive a validation notification indicating the first portion of the first alphanumeric code matches the dynamic authentication code.

41. The system of claim 37, wherein the first portion of the first alphanumeric code is presented via a display of an electronic device having a credit card form factor with credit card dimensions;
wherein the electronic device is devoid of an antenna;
wherein the fuel dispensing pump is an electric vehicle charging station;
wherein the second portion of the first alphanumeric code is shorter than the first portion of the first alphanumeric code; and
wherein the first alphanumeric code further comprises a third portion that is static, and wherein the first alphanumeric code has a sequence of the third portion, the second portion, and the first portion
